(19) United States
(12) Patent Application Publication
(10) Pub. No.: US 2013/0105518 A1
(43) Pub. Date: May 2, 2013

(54) CELL PHONE COVER SELF-DEFENSE APPARATUS

(71) Applicant: ISPRAY, LLC, Scottsdale, AZ (US)

(72) Inventors: Scott McPherson, Paradise Valley, AZ (US); Ben Dameron, Coronado, CA (US); Morten Jensen, Mesa, AZ (US)

(73) Assignee: ISPRAY, LLC, Scottsdale, AZ (US)

(21) Appl. No.: 13/648,102

(22) Filed: Oct. 9, 2012

Related U.S. Application Data
(60) Provisional application No. 61/553,590, filed on Oct. 31, 2011.
(60) Provisional application No. 61/578,434, filed on Dec. 21, 2011.

(51) Int. Cl. B65D 83/38; B65D 83/22; A45C 15/00; B67D 1/07

(52) U.S. Cl. 222/153.11; 222/183; 206/38; 222/192

(57) ABSTRACT

A cell phone cover includes a compartment comprising an external bulge located on the rear wall of the housing. The compartment is adapted to contain a canister of pepper spray oriented so that the longitudinal axis of the canister is transverse to the long edge of the cell phone and is offset towards the top edge of the cell phone. The rearward and longitudinal orientation of the pepper spray canister compartment enables the compartment to act as a prop to incline the screen toward the user when the cell phone is placed on a table with the screen in a “portrait” orientation. The rearward and longitudinal orientation of the pepper spray canister also enables the compartment to act as a kickstand when the cell phone is placed on a table with the screen in the “landscape” orientation.

### BACKGROUND OF THE INVENTION

This invention relates generally to non-lethal self defense apparatus.

Each year, many people are victims or potential victims of violent crime. According to the U.S. Census Bureau, in 2009, over 10 million people in America were victims of violent crime. A shocking 1.3 million American children under the age of 18 were murdered in 2009. Police forces, which in the United States average less than 2.5 officers per 1000 citizens, simply cannot effectively prevent violent crimes against individuals. Accordingly, the primary responsibility for personal protection rests with the individual.

Various apparatus exist to enable an individual citizen to defend against an attacker, including firearms, stun guns, and chemical sprays. A firearm, when in the hands of a properly trained individual, is certainly an effective deterrent, however, most ordinary citizens cannot devote the time or energy to become proficient at handling a firearm in an emergency situation. Most will instinctively hesitate before using deadly force to stop an attack. In such a situation, the firearm can be used against the victim with grave consequences. Moreover, a firearm is only an effective deterrent if the potential victim remembers to carry it at all times (e.g. on short errands, when jogging, when going to the beach, etc.).

Non-lethal personal protection devices such as stun guns, including the TASER® stun gun, have the advantage over a firearm in that because they are non-lethal, an ordinary citizen will be less likely to hesitate before using them to stop an aggressor. Such devices, however, still require the citizen to devote time and energy to become proficient enough to hit the target in an emergency situation. Stun guns are often bulky and therefore awkward to carry and, as with a firearm, are only effective if the victim remembers to carry the device at all times. Aerosol deterrents such as MACE®, pepper spray and tear gas, similarly have the advantage of being non-lethal and are generally more compact and, therefore, easier to carry than stun guns, however, still suffer from the disadvantage that the potential victim must remember to carry the aerosol deterrent at all times.

According to a recent estimate, there are now over 4 billion cell phones in use throughout the world. It is estimated that in the United States, cell phone market saturation will soon be over 100%, with many people carrying two or more wireless-enabled devices including cell phones, PDAs (smart phones) and wireless tablet computers. For most people in first-world countries, carrying a cell phone is as essential as carrying a wallet. In fact, a cell phone equipped with an application such as the GOOGLE® wallet may replace the traditional wallet as the single item most people will carry with them at all times. Because most people already carry a cell phone, incorporation of a personal protection device into a cell phone overcomes the problems associated with neglecting to carry the personal protection device.

U.S. Pat. No. 5,988,450 issued to Cassarino discloses a combination cell phone and personal defense system in which a cartridge of pepper spray is incorporated within the cell phone housing. A button on the side of the housing enables the user to discharge the pepper spray from the cartridge in the event of an attack. A disadvantage of the personal defense system of Cassarino, however, is that since the pepper spray cartridge is incorporated within the cell phone housing itself, the cell phone of Cassarino could not be carried onto a commercial aircraft or into other places where carrying pepper spray is prohibited. Other disadvantages include the fact that the cell phone would have to be disassembled to replace the cartridge and the location of the nozzle does not facilitate intuitive aiming of the pepper spray and, therefore, in an emergency, the user may miss the target. Finally, given the substantial volume occupied by a pepper spray cartridge, it is simply not feasible to incorporate a pepper spray cartridge within the confines of a modern day smart phone housing.

Considering the substantial cost of a modern 3G or 4G smart phone, it is not surprising that most people who own smart phones purchase some sort of cell phone cover to protect it. Cell phone covers are sometimes made of leather, but are more often made of a rigid silicone, flexible thermoplastic polyurethane, ABS, polycarbonate or other material that protects the shell of the smart phone from impact and scratches. Prior art cell phone covers also come equipped in some instances with various accessories such as a kickstand, screen cover, belt clip, and/or ID pouch. None, however, contain a personal protection device such as a pepper spray cartridge. Accordingly, what is needed is a cell phone cover (as opposed to the cell phone itself) that includes a personal protection device such as a pepper spray cartridge.

### SUMMARY OF THE INVENTION

The present invention comprises a cell phone cover that includes a compartment for carrying an aerosol canister such as a pepper spray cartridge (as used herein “cell phone cover” includes covers for cellular phones, smart phones, MP3 players or other devices having a similar form). According to an illustrative embodiment, the cell phone cover includes a compartment comprising an external bulge located on the rear wall of the housing. The compartment is adapted to contain a canister of pepper spray oriented so that the longitudinal axis of the canister is transverse to the long edge of the cell phone and is offset towards the top edge of the cell phone. The rearward and longitudinal orientation of the pepper spray canister compartment enables the compartment to act as a prop to incline the screen toward the user when the cell phone is placed on a table with the screen in a “portrait” orientation. The rearward and longitudinal orientation of the pepper spray canister also enables the compartment to act as a kickstand when the cell phone is placed on a table with the screen in the “landscape” orientation.

In the illustrative embodiment, the pepper spray canister is discharged through a nozzle oriented substantially orthogonal to the longitudinal axis of the canister, similar to an ordinary aerosol can. The nozzle aligns with an aperture formed in the compartment when the nozzle is rotated to the armed position and depressed. This enables the user to aim the pepper spray at an attacker simply by aiming the cell phone in a manner similar to the manner in which the cell phone is aimed for the purpose of taking photograph with the cell phone camera, and thus is a natural, instinctive aiming method for most users. In the illustrative embodiment, the compartment is attached to the cell phone cover by means of a dovetail joint, which enables the compartment and pepper spray canister to be removed as needed, for example, when boarding a commercial aircraft. A mobile software application may be included, which activates the cell phone camera and camera flash when the pepper spray is discharged, the camera flash acting to disorient and the camera acting to record the identity of the would-be attacker for law enforcement purposes. The mobile software application may also be programmed to forward the photograph and GPS coordinates to a pre-programmed address, such as that of the police or an alarm monitoring company via SMS (text message), e-mail or other communications protocol.

### BRIEF DESCRIPTION OF THE DRAWING

The present invention will be better understood from a reading of the following detailed description, taken in conjunction with the accompanying drawing figures in which like references designate like elements and, in which:

FIG. 1 is a front perspective view of a cell phone cover incorporating features of the present invention;

FIG. 2 is an exploded rear perspective view, partially cutaway of the cell phone cover of FIG. 1;

FIG. 3 is a rear perspective view of the cell phone cover of FIG. 1 with the aerosol canister in the unarmed, safe position;

FIG. 4 is a rear perspective view of the cell phone cover of FIG. 3 with the aerosol canister in the unarmed position;

FIG. 5 is a rear perspective view of the cell phone cover of FIG. 3 with the aerosol canister in the armed position; and

FIG. 6 is a rear perspective view of a cell phone cover of FIG. 3 with the aerosol canister in the firing position.

### DETAILED DESCRIPTION

The drawing figures are intended to illustrate the general manner of construction and are not necessarily to scale. In the detailed description and in the drawing figures, specific illustrative examples are shown and herein described in detail. It should be understood, however, that the drawing figures and detailed description are not intended to limit the invention to the particular form disclosed, but are merely illustrative and intended to teach one of ordinary skill how to make and/or use the invention claimed herein and for setting forth the best mode for carrying out the invention.

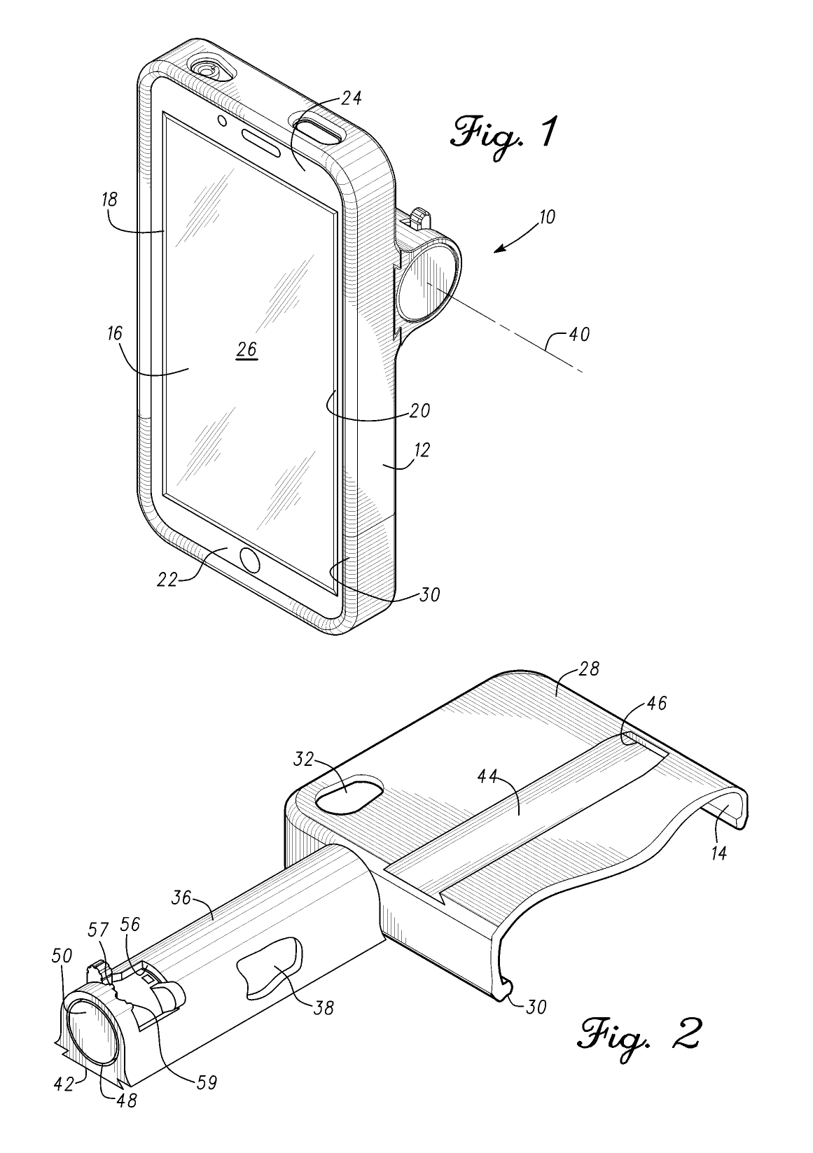

With reference to FIGS. 1 and 2, a cell phone cover 10 incorporating features of the present invention comprises a housing 12 having an interior cavity 14 adapted to receive and conform closely to the exterior surface of a cell phone 16. Cell phone cover 10 may be formed of aluminum, silicone, polyurethane, ABS, polycarbonate or other material suitable for protecting the exterior surface of cell phone 16 from damage. In the illustrative embodiment, cell phone 16 comprises a smart phone having a generally rectangular shape with long edges 18 and 20 as well as a shorter bottom edge 22 and top edge 24. Cell phone 16 further comprises a screen 26 for displaying information to the user and/or receiving user input. Interior cavity 14 of housing 12 comprises a substantially closed rear wall 28 and a front wall 30 which is substantially open to reveal screen 26 of cell phone 16. Although rear wall 28 is substantially closed it may include apertures, such as aperture 32 to enable the camera lens of cell phone 16 to see through rear wall 28 of housing 12

Cell phone cover 10 further includes a compartment 36 which contains an aerosol canister 38. Aerosol canister 38 preferably comprises a substantially cylindrical canister having a longitudinal axis 40 and containing approximately 4 grams of 10% oleoresin capsicum under pressure. Aerosol canister 38 further comprises a discharge nozzle 50 which is depressed axially downward to release the contents of aerosol canister 38 as explained more fully hereinafter. Compartment 36 is attached to housing 12 by engaging a tab 42 formed on compartment 36 into a dovetail groove 44 formed in rear wall 28 of housing 12. Dovetail groove 44 includes an end wall 46 which acts as a stop to prevent compartment 36 from moving out of the position shown in FIG. 1 when discharge nozzle 50 is depressed.

As can be determined from an inspection of FIGS. 1 and 2, when assembled, compartment 36 forms an external bulge on the rear wall of housing 12 with the longitudinal axis 40 of aerosol canister 38 substantially orthogonal to the long edge (20 or 22) of cell phone 16. The longitudinal axis 40 of canister 38 is also displaced toward the top edge 24 of cell phone 16 (i.e. it is closer to the top edge 24 of cell phone 16 than it is to the bottom edge 22 of cell phone 16). The rearward and longitudinal orientation of compartment 36 enables the compartment to act as a prop to incline screen 26 toward the user when the cell phone is placed on a table or other horizontal surface with the screen in a “portrait” orientation. Because canister 38 has mass, the presence of canister 38 within compartment 36 moves the center of mass of the cell phone and cell phone cover rearward. The rearward and longitudinal orientation of canister 36 then enables the compartment to act as a kickstand when cell phone is placed on a table with the screen in the “landscape” orientation. Thus, compartment 36 combines the functions of a cell phone kickstand, a cell phone prop and a pepper spray container into a single housing.

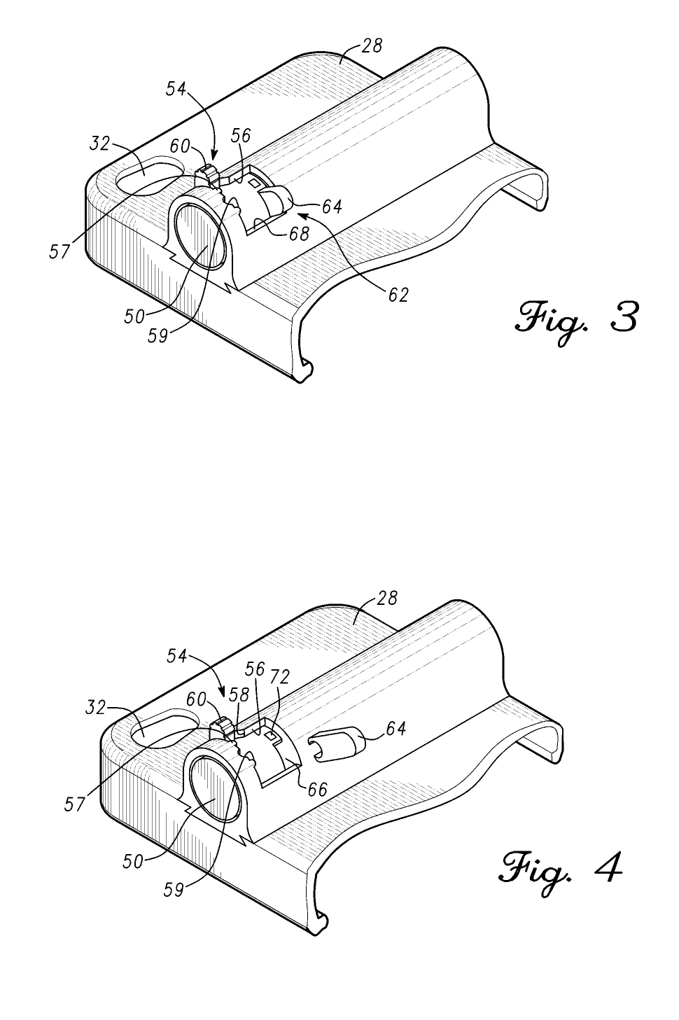

With additional reference to FIGS. 3-6, discharge nozzle 50 comprises a substantially cylindrical aerosol cap including a 90° passage which provides a fluid passage from the aerosol canister 38 to an exit opening 52 oriented substantially orthogonal to longitudinal axis 40 of aerosol canister 38. Aerosol canister 38 includes a conventional aerosol valve (not shown) which, when depressed by discharge nozzle 50, opens to release its contents in a conventional manner. Discharge nozzle 50 is depressed by the user through a circular aperture 48 formed in compartment 36 as shown most clearly in FIG. 6.

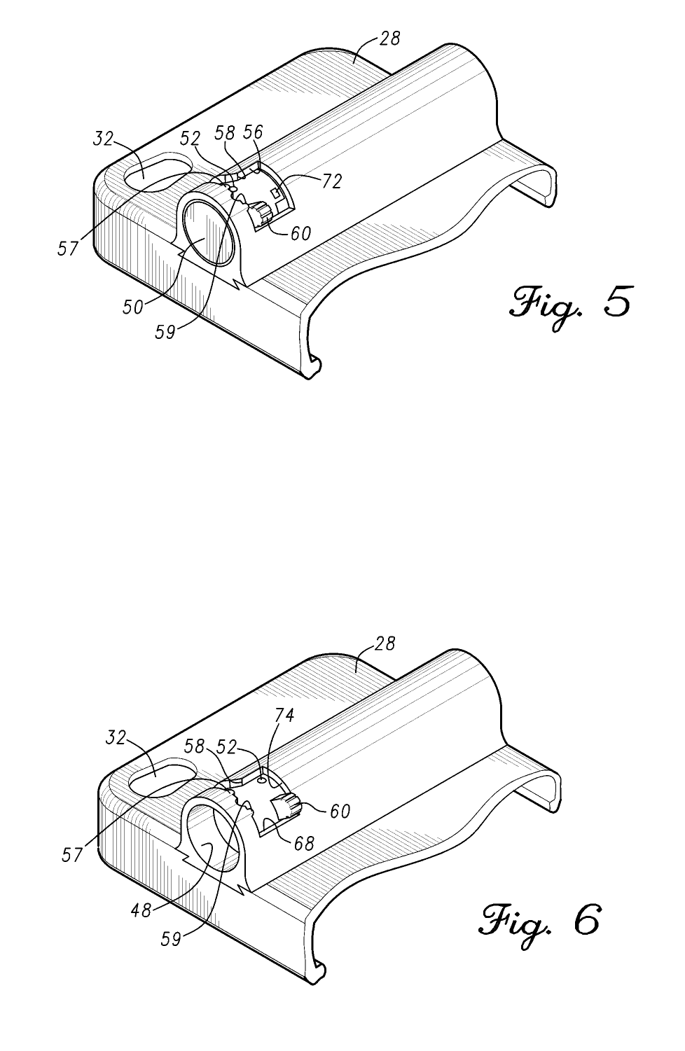

Discharge nozzle 50 is rotatable about axis 40 of aerosol canister 38 from a position as shown in FIG. 3 in which exit opening 52 is obscured by compartment 36 to the firing position as shown in FIGS. 5 and 6 in which exit opening 52 is visible through an aperture 56 having a substantially pan-shaped outline.

Discharge nozzle 50 includes a safety interlock 54 to prevent accidental discharge of the contents of aerosol canister 38. The lower surface 58 of aperture 56 forms a cam surface. Safety interlock 54 comprises a tab 60, which is press-fit into a socket formed in discharge nozzle 50. Tab 60 acts as a cam follower which engages lower surface 58 to prevent discharge nozzle 50 from being depressed until discharge nozzle 50 has been rotated sufficiently such that tab 60 has cleared lower surface 58 of aperture 56. Although safety interlock 54 is press-fit to discharge nozzle 50, safety interlock 54 could be bonded to, molded as part of, or otherwise attached or formed on discharge nozzle 50. Accordingly, the invention should not be limited to any particular method of assembly of discharge nozzle 50.

Compartment 36 includes an additional safety interlock 62, which prevents discharge nozzle 50 from rotating into the firing position. Safety interlock 62 comprises a clip 64 which is inserted through a slot 66 formed in discharge nozzle 50. Clip 64 includes a snap fitting that grips the valve stem of aerosol canister 38 to retain clip 64 in position. With clip 64 in place as shown in FIG. 3, discharge nozzle 50 is prevented from rotating into the firing position by the interference between clip 64 and the edge 68 of aperture 56 and is prevented from being depressed by the interference between clip 64 and slot 66. With clip 64 removed as shown in FIG. 4, discharge nozzle 50 may be rotated into the firing position by manipulating tab 60 and may be depressed without obstruction.

As is apparent from the foregoing, in order to deter an attacker, the user simply removes clip 64 then, by pressing on tab 60, the user rotates discharge nozzle 50 approximately 45° until tab 60 comes to rest against the edge 68. As discharge nozzle 50 rotates, tab 60 passes first over detent 57 which provides tactile feedback that discharge nozzle 50 has moved out of its stored position. As discharge nozzle 50 continues to rotate, tab 60 passes over detent 59, which provides tactile feedback that discharge nozzle 50 has moved to its fully armed position. At this point, exit opening 52 is aligned with aperture 56 formed in compartment 36. The user then aims the cell phone as if preparing to take a photograph and depresses discharge nozzle 50 by pressing on discharge nozzle 50 through aperture 48. Because discharge nozzle 50 is essentially aligned with the field of view of the camera lens, aiming the pepper spray nozzle of the present invention is virtually identical to aiming a cell phone for the purpose of taking a photograph with the cell phone camera. Therefore, aiming the pepper spray nozzle of the present invention is a natural, intuitive aiming method for most users.

Additionally, because the field of view of the cell phone camera will inherently be aimed at the attacker, in an alternative embodiment of the present invention, cell phone cover 10 is provided with means for activating the cell phone camera and/or flash, for example by embedding an RFID tag 72 in discharge nozzle 50 and a magnet or Faraday shield near the lower surface 74 of aperture 56. As discharge nozzle 50 is depressed, the signal from RFID tag 72 would be disrupted by the magnet or Faraday shield. A mobile software application running on the cell phone would detect the disruption of the RFID signal and activate the camera and/or flash, the camera flash acting to disorient and the camera acting to record the identity of the would-be attacker for law enforcement purposes. The mobile software application may also be programmed to forward the photograph and GPS coordinates of the attacker to a pre-programmed address, such as that of the police or an alarm monitoring company via SMS (text message), e-mail or other communications protocol. Providing the real-time coordinates and photograph of the now-disabled attacker would likely prove invaluable in apprehending the would-be attacker.

Although certain illustrative embodiments and methods have been disclosed herein, it will be apparent from the foregoing disclosure to those skilled in the art that variations and modifications of such embodiments and methods may be made without departing from the invention. For example, in lieu of RFID tag 72 and Faraday shield, a simple reed switch or other contact switch could be incorporated into the present invention to provide the signal to activate the camera and/or flash. Similarly, although in the illustrative embodiment aerosol canister 38 comprises a container of pepper spray, other self defense/alarm apparatus could be substituted for aerosol canister 38, including a sonic generator or other non-lethal apparatus. Accordingly, it is intended that the invention should be limited only to the extent required by the appended claims and the rules and principles of applicable law. Additionally, as used herein, references to direction such as “up” or “down” are intend to be exemplary and are not considered as limiting the invention and, unless otherwise specifically defined, the terms “substantially” or “approximately” when used with mathematical concepts or measurements mean within ±10 degrees of angle or within 10 percent of the measurement, whichever is greater.

What is claimed is:

1. A cell phone cover incorporating a personal defense system, the cell phone cover adapted to encase a cell phone having a front surface with a display screen located thereon, the cell phone comprising a body having a substantially rectangular prismatic form with a long side, a short side and a thickness, the cell phone cover comprising:
a housing formed of an impact-resistant material having an inner surface adapted to conform closely to the outer surface of a cell phone, the housing having a front wall with an opening to reveal the cell phone screen and a rear wall opposite the front wall;
a compartment comprising an external bulge located on the rear wall of the housing, the external bulge having a top end, a bottom end and a longitudinal axis extending between the top end and the bottom end, the external bulge further comprising an interior cavity adapted to receive a substantially cylindrical canister, the canister being received so that the center of volume of the canister is located behind the rear surface of the cell phone and the longitudinal axis of the canister is transverse to the long side of the cell phone.

2. The cell phone cover of claim 1, further comprising:
an aerosol canister contained within the interior cavity of the external bulge, wherein the aerosol canister comprises a discharge nozzle having an exit opening oriented substantially orthogonal to the longitudinal axis of the canister, the discharge nozzle adapted to be depressed axially to release the contents of the canister.

3. The cell phone cover of claim 2, wherein:
the discharge nozzle is rotatable about the longitudinal axis of the canister.

4. The cell phone cover of claim 3, further comprising:
a first aperture formed in a lateral wall of the compartment, the first aperture extending into the interior cavity and aligning with the exit aperture of the discharge nozzle when the discharge nozzle is rotated to a predetermined rotational position.

5. The cell phone cover of claim 4, further comprising:
a first nozzle interlock for preventing accidental discharge of the aerosol canister, the nozzle interlock comprising a cam surface formed along a lower edge of the first aperture and a cam follower operatively attached to the discharge nozzle, the cam follower engaging the cam surface to prevent the discharge nozzle from being depressed until the nozzle is rotated to the predetermined rotational position.

6. The cell phone cover of claim 5, further comprising:
a second aperture, the second aperture formed in the top wall of the compartment, the second aperture extending into the interior cavity and aligning with an upper surface of the discharge nozzle, whereby the discharge nozzle may be depressed by a user pressing the upper surface of the discharge nozzle through the second aperture.

7. The cell phone cover of claim 6, wherein:
The upper surface of the discharge nozzle is flush with the top surface of the external bulge when the discharge nozzle is not depressed.

8. The cell phone cover of claim 5, wherein:
The compartment is detachable from the housing.

9. The cell phone cover of claim 8, further comprising:
A dovetail joint formed between the compartment and the housing, the dovetail joint including an internal stop surface to prevent the compartment from moving when the discharge nozzle is depressed by the user.

10. The cell phone cover of claim 6, further comprising:
a second nozzle interlock for preventing accidental discharge of the aerosol canister, the second nozzle interlock comprising a clip operatively attached to the discharge nozzle, the clip having a surface engaging a lateral edge of the first aperture to prevent rotation of the discharge nozzle, the pin being removable to allow rotation of the discharge nozzle to the predetermined rotational position.

11. A cell phone cover incorporating a personal defense system, the cell phone cover adapted to encase a cell phone having a front surface with a display screen located thereon and a rear surface having a camera lens located thereon, the camera lens having a field of view, the cell phone comprising a body having a substantially rectangular prismatic form with a long side, a short side and a thickness, the cell phone cover comprising:
a housing formed of an impact-resistant material having an inner surface adapted to conform closely to the outer surface of a cell phone, the housing having a front wall with an opening to reveal the cell phone screen and a rear wall opposite the front wall;
a compartment comprising an external bulge located on the rear wall of the housing, the external bulge having a top end, a bottom end and a longitudinal axis extending between the top end and the bottom end, the external bulge further comprising an interior cavity adapted to receive a substantially cylindrical canister, the canister being received so that the center of volume of the canister is located behind the rear surface of the cell phone and the longitudinal axis of the canister is transverse to the long side of the cell phone; and
an aerosol canister contained within the interior cavity of the external bulge, wherein the aerosol canister comprises a discharge nozzle having an exit opening oriented substantially parallel to the camera lens field of view, the discharge nozzle adapted to be depressed axially to release the contents of the canister.
